(19) United States
(12) Patent Application Publication
(10) Pub. No.: US 2002/0143762 A1
(43) Pub. Date: Oct. 3, 2002

(54) Envelope printing feature for photo filing system

(76) Inventors: David W. Boyd, Greeley, CO (US); Michelle Lehmeier, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/824,117

(22) Filed: Apr. 2, 2001

(51) Int. Cl. G06K 9/54; G06K 9/60; G06K 1/00; G06F 15/00; B41F 1/00; B41B 1/00; B41J 1/00

(52) U.S. Cl. 707/6; 382/305; 358/1.18

(57) ABSTRACT

The present invention creates a thumbnail representation from a received digital representation of a photograph and associates retrieval information with said thumbnail representation. Also, the present invention associates a label identifier with said photograph. The label identifier is printed to facilitate retrieval of photographs stored in a storage structure.

### BACKGROUND

At the present time, most consumers do not store personal photographs in any type of ordered or organized manner. At best, consumers select favorite photographs for placement in a photograph album. However, consumers frequently generate large numbers of photographs from various family gatherings, holidays, vacations, graduations, social events, and/or the like. Most photographs are simply retained in the envelope received from the photograph developer and placed into a closet, a shoe box, or a drawer for storage. Over time, it may be quite time consuming to retrieve or locate a specific photograph associated with a specific location or a specific event.

Systems implemented on computer systems do exist to organize certain photographic material for professional photographers. These systems are tailored for professionals and therefore operate to address their specific needs. For example, these systems are directed to maintenance of one specific type of photographic medium—such as 35 mm transparencies (e.g. slides). Moreover, the systems presume that a physical structural storage mechanism already exists. Accordingly, the systems create labels containing arbitrary numerical identifiers, which may be attached to the various transparencies to facilitate location of transparencies with the storage structure. The arbitrary numerical identifiers uniquely identify particular slides, since it is assumed that the slides will be stored in an organized manner. These systems do maintain a database which correlates keywords or text descriptions to individual identifiers. These keywords or text descriptions are entered by a user. It is generally assumed that a professional photographer will be interested in entering data for most photographs, since the professional photographer utilizes the storage system as a means to manage his or her professional work product. Also, the systems also associate thumbnail representations of transparencies with identifiers.

### SUMMARY OF THE INVENTION

The present invention is directed to a system and method which facilitate storage and retrieval of photographs. In particular, the present invention does not assume that the system and method will be utilized strictly by professional photographers and therefore does not suffer from the presumptions of known systems. The present invention does not assume that a consumer will always be interested in entering data for each photograph. Instead, the present invention preferably associates automatically generated meta-data with photographs via a database.

Moreover, the present invention does not assume that a consumer has pre-created an extensive structural storage system designed to retain years of photographs. The present invention recognizes that most consumers will simply store photographs in the envelopes received from their photograph developers. Accordingly, the present invention preferably creates a label that may comprise various organizational information that may be attached to such developer envelopes. Also, the organization information is retained in a database to facilitate retrieval of photographs associated with particular envelopes.

The present invention recognizes that a consumer may retain different types of photographs. For example, a consumer may possess a digital camera and an ordinary 35 mm camera. The present invention allows such a consumer to manage storage of both types of photographs utilizing the same database information. Also, the database may be configured to retain information specific to each type of photograph. For example, the database may allow a consumer to correlate the location of photographs with their corresponding negatives.

In an embodiment, the present invention may be implemented as a database application. The database application may include a software interface for receiving a digital representation of a photograph. The database application may include a routine for creating a thumbnail representation from the digital representation and another routine for associating retrieval information with said thumbnail representation. The database application may associate a label identifier with said photograph. The database application may generate and print a label including the label identifier. Also, the database application may retain a database of information including thumbnail representations, retrieval information, and label identifiers. Also, the label identifiers uniquely identify storage structures containing numerous photographs to allow a user to easily retrieve physical copies of photographs.

### BRIEF DESCRIPTION OF THE DRAWING

FIG. 1 depicts a flowchart of various steps utilized in association with a photograph database application according to a preferred embodiment of the present invention.

FIG. 2 depicts a flowchart of various steps associated with retrieval of photographs via database query operations according to a preferred embodiment of the present invention.

FIG. 3 depicts a block diagram of a computer system which is adapted to use the present invention.

### DETAILED DESCRIPTION

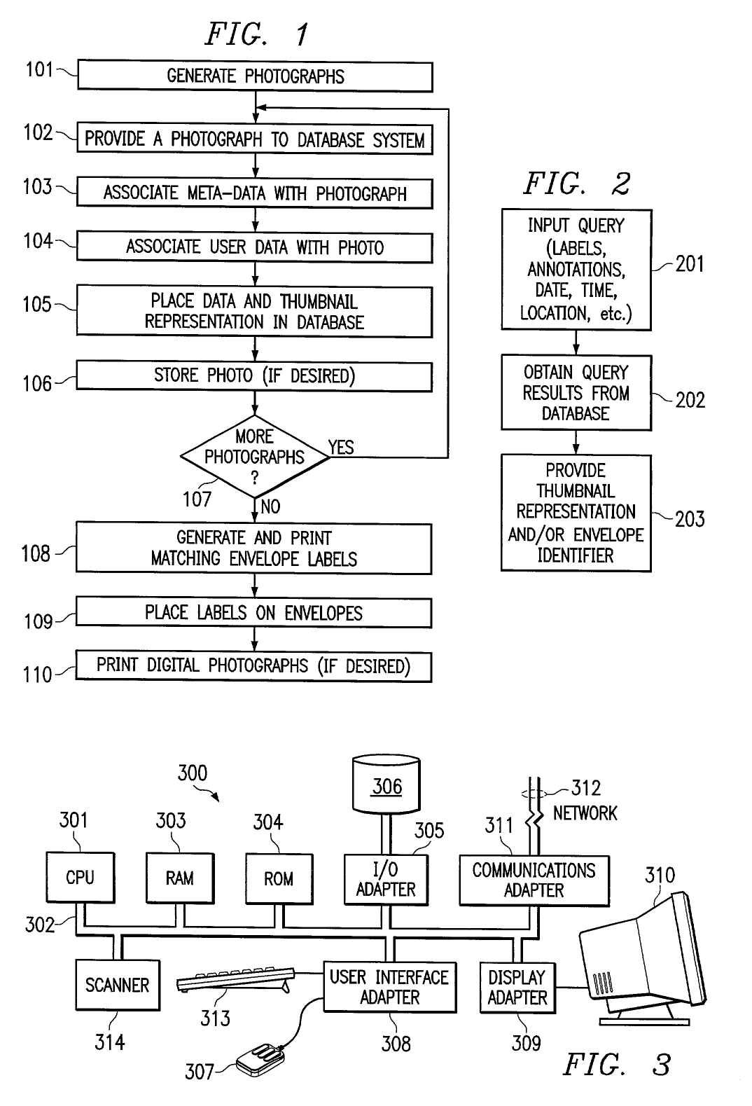

FIG. 1 depicts a flowchart of various steps utilized in association with a photograph database application. In step 101, a user generates a number of photographs. The user may generate the photographs utilizing any type of mechanism as desired by the user. For example, the user may take the photographs with an inexpensive disposable camera. Alternatively, the user may take the photographs with a relatively complex digital camera. To facilitate an embodiment of the present invention, a specific digital camera designed to operate with the present invention may be utilized. Specifically, a digital camera that possesses a global position system (GPS) receiver may be employed. The digital camera utilizes the GPS receiver to associate GPS coordinates with photographs at the time the photographs are taken. The GPS coordinates are stored as meta-data associated with the digital representations of the photographs. Additionally, the GPS capable digital camera may be supplied a database via a non-volatile memory element (such as flash memory, EPROM, EEPROM, and/or the like) which may allow the camera to associate GPS coordinates with specific locations. For example, the digital camera may be able to ascertain from GPS coordinates that a picture was taken in Seattle. The digital camera may associate the specific location (street, city, state, and/or the like) with the photograph as meta-data.

The present invention may be utilized to provide storage structure identifiers and database retrieval for any other photographic formats such as APS, 4×5, and/or the like. Also, the present invention may be utilized to provide storage structure identifiers and database retrieval for photographic negatives such as 35 mm negatives. It shall be appreciated that any reference to photograph or photographs should be interpreted to include any such formats.

In step 102, a photograph is provided to a database application. If the photograph is a physical copy received from a developer, the photograph may be provided to the database application via a scanner and a software interface. It the photograph is a digital photograph taken by a digital camera, the photograph may be downloaded from the digital camera to the database application via an appropriate port and a software interface. It shall be appreciated that the present invention does not necessarily require scanning of the photographic image. Accordingly, this step may be omitted by the user if desired. The user may utilize the database information tracking mechanisms (as will be discussed in greater detail below) without associating the database information with thumbnail representations of the photographs.

In step 103, meta-data (if the photograph was taken by a camera capable of producing meta-data) is associated with the provided photograph. Meta-data refers to data that is automatically produced when a photograph is taken. For example, meta-data would include the GPS coordinates if the photograph was taken by a GPS receiver-enabled digital camera. Also, many digital cameras associate time and date information with each photograph. Time and date meta-data may be associated with the photograph for retrieval purposes. Other meta-data may be associated with the photograph such as a voice annotation. The meta-data may identify the type of camera utilized. For example, the meta-data may identify the model number of the digital camera. The preceding examples are merely exemplary. Any type of auto-generated meta-data may be associated with the photograph depending upon the capability of a given camera.

In step 104, user data is associated with the photograph. A user may type various keywords or various text descriptions for association with the photograph. For example, a user may associate Christmas 2000, Hawaii with a photograph. Any number of keywords or text identifiers may be utilized.

In step 105, the meta-data, user data, and a thumbnail representation generated from the full digital representation are placed into the database. In step 106, the full digital representation of the photograph may be stored if desired. However, many users prefer to retain photographs (even digital photographs) in printed form rather than digital form. Specifically, many consumers may not possess sufficient storage capacity to retain a large number of digital image files. Accordingly, the user may omit storage of the full digital representation if desired.

In step 107, it is determined whether additional photographs are to be entered. If so, steps 102 through 107 are repeated. If not, the database application generates and prints a user label or user labels that may be affixed to a storage structure or structures which will be used to retain the various photographs (step 108). For example, the user may place the photographs back into the developer envelope. The label may be affixed onto the developer envelope. Alternatively, the present invention may print label information directly onto a storage envelope if desired by a user.

The label or labels may contain various identification information. First, the database application preferably automatically creates a unique identifier to be associated with a particular storage structure. The unique identifier is associated with each photograph that will be retained in the respective storage structure to facilitate retrieval of the photographs. Additionally, the unique identifier is printed on the label. Moreover, the database application preferably allows the user to provide a more meaningful text description that will be associated with the storage structure if desired. Additionally or alternatively, the user may select a thumbnail representation to be printed on the label. For example, the user may select a beach view photograph to be associated with an envelope of photographs taken in Hawaii.

In step 109, the user places the label on the envelope or other structural container such as a photograph album or box.

In step 110, the user may print digital photographs if desired. Even though digital photographs are now quite common, many consumers do not prefer to retain digital photographs solely on traditional computer media. Instead, many consumers wish to retain hard copies of the photographs. Accordingly, the hard copies of digital photographs may be printed and placed in a labeled envelope for future retrieval if desired by a particular user. The user may then places the photographs in the storage structure for storage.

FIG. 2 depicts a flowchart of various steps associated with retrieval of photographs via database query operations. In step 201, a user may submit a photograph query to the database application. The query may include criteria for any field associated with the photographs. The query may contain conditions pertaining to meta-data. In particular, the user may enter approximate GPS coordinates if photograph data has been placed into database from a digital GPS capable camera. For example, a user may not be able to recall exactly when a photograph was taken. However, the user may remember that the photograph was taken at a family gathering held in a particular city. The user may utilize the location information to retrieve the desired photograph. Of course, the user may additionally or alternatively enter other information such as date, time, type of camera, annotations, and/or the like.

In step 202, the database application obtains query results by applying the user-provided criteria to the database information. In step 203, the database application provides the query results by displaying thumbnail representations of photographs matching the query to the user. The database application may simultaneously or alternatively provide label identifiers. The database application may allow the user to click on the thumbnail representations of the photographs to obtain additional information associated with the photographs such as text descriptions. By providing the user with the label identifiers associated with the query results, the user is able to quickly identify the envelope or other storage structure associated with the desired photographs.

When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

FIG. 3 illustrates computer system 300 adapted to use the present invention. Central processing unit (CPU) 301 is coupled to system bus 302. The CPU 301 may be any general purpose CPU, such as a Hewlett Packard PA-8500 or Intel Pentium processor. However, the present invention is not restricted by the architecture of CPU 301 as long as CPU 301 supports the inventive operations as described herein. Bus 302 is coupled to random access memory (RAM) 303, which may be SRAM, DRAM, SDRAM, or any other type of volatile memory. ROM 304 is also coupled to bus 302, which may be PROM, EPROM, or EEPROM. RAM 303 and ROM 304 hold user and system data and programs as is well known in the art.

Bus 302 is also coupled to input/output (I/O) controller card 305, communications adapter card 311, user interface card 308, and display card 309. The I/O card 305 connects to storage devices 306, such as one or more of hard drive, CD drive, floppy disk drive, tape drive, to the computer system. Communications card 311 is adapted to couple the computer system 300 to a network 312, which may be one or more of telephone network, local (LAN) and/or wide-area (WAN) network, Ethernet network, and/or Internet network. User interface card 308 couples user input devices, such as keyboard 313 and pointing device 307, to the computer system 300. The display card 309 is driven by CPU 301 to control the display on display device 310. Scanner 314 may be utilized to generate digital images, from photographs for example, for processing by CPU 301.

What is claimed is:

1. A system for facilitating retrieval of photographs, comprising:
first software code for creating a thumbnail representation from a digital representation of a photograph;
second software code for associating retrieval information with said thumbnail representation;
third software code for associating a label identifier with said photograph; and
fourth software code for generating and printing a label including a label identifier.

2. The system of claim 1 wherein a software interface enables a user to provide the digital representation by scanning a photograph.

3. The system of claim 1 wherein a software interface enables a user to provide the digital representation by downloading the digital representation from a digital camera.

4. The system of claim 1 wherein the retrieval information includes meta-data.

5. The system of claim 4 wherein the meta-data includes global positioning system (GPS) coordinates.

6. The system of claim 4 wherein the meta-data includes voice annotations.

7. The system of claim 1 further comprising:
a database for storing thumbnail representations, retrieval information, and label identifiers, wherein each of said label identifiers uniquely identifies a storage structure that is utilized to store a plurality of photographs.

8. A system for facilitating retrieval of photographs, comprising:
means for creating a thumbnail representation from a digital representation of a photograph;
means for associating retrieval information with said thumbnail representation;
means for associating a label identifier with said photograph; and
means for generating and printing a label including a label identifier.

9. The system of claim 8 wherein a means for receiving enables a user to provide the digital representation by scanning a photograph.

10. The system of claim 8 wherein a means for receiving enables a user to provide the digital representation by downloading the digital representation from a digital camera.

11. The system of claim 8 wherein the retrieval information includes meta-data.

12. The system of claim 11 wherein the meta-data includes global positioning system (GPS) coordinates.

13. The system of claim 11 wherein the meta-data includes voice annotations.

14. The system of claim 8 further comprising:
a database for storing thumbnail representations, retrieval information, and label identifiers, wherein each of said label identifiers uniquely identifies a storage structure that is utilized to store a plurality of photographs.

15. A method for facilitating retrieval of photographs, comprising:
receiving retrieval information associated with a plurality of photographs;
associating a storage structure identifier with said plurality of photographs, wherein said storage structure identifier is utilized to identify a storage structure utilized to retain said plurality of photographs;
storing said retrieval information and said storage structure identifier in a database; and
printing a label wherein said label comprises said storage structure identifier.

16. The method of claim 15 further comprising:
receiving a database query from a user to identify desired photographs;
matching said database query to said database to identify matching photographs; and
presenting storage structure identifiers associated with said matching photographs to assist the user in locating said matching photographs.

17. The method of claim 16 wherein said retrieval information includes meta-data received from a digital camera.

18. The method of claim 17 wherein said meta-data includes global positioning system (GPS) coordinates.

19. The method of claim 15 further comprising:
receiving a digital representation of photographs;
generating thumbnail representations of said photographs; and
storing said thumbnail representations in said database.

20. The method of claim 19 wherein said step of printing includes printing a thumbnail representation on said label.
